(19) United States
(12) Patent Application Publication
(10) Pub. No.: US 2010/0211751 A1
(43) Pub. Date: Aug. 19, 2010

(54) Program Execution Apparatus, Program Execution Method, and Program

(76) Inventor: Katsuki Uwatoko, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/622,834

(22) Filed: Nov. 20, 2009

(30) Foreign Application Priority Data
Feb. 13, 2009 (JP) 2009-031433

(51) Int. Cl. G06F 9/46; G06F 12/00

(52) U.S. Cl. 711/154; 718/102; 711/E12.001

(57) ABSTRACT

According to one embodiment, a program execution apparatus includes a first memory configured to store a first program, a second memory configured to store a partial program loaded from the first memory or a second program loaded from one other memory, and a controller configured to perform first correspondence to cause a first storage region of the first program in the first memory to correspond to a first virtual region of a virtual memory, execute the first program stored in the first memory on the basis of the first correspondence according to a request for the execution of the first program.

### CROSS-REFERENCE TO RELATED APPLICATIONS

This application is based upon and claims the benefit of priority from Japanese Patent Application No. 2009-031433, filed Feb. 13, 2009, the entire contents of which are incorporated herein by reference.

### BACKGROUND

1. Field

One embodiment of the invention relates to a program execution apparatus and a program execution method which execute a boot program and a program which can be applied to the program execution apparatus.

2. Description of the Related Art

One typical device controlled by a central processing unit (CPU) is a personal computer. With the recent popularization of digital video apparatuses, not only digital TVs but also hard disk recorders are controlled by a CPU.

The CPU expands the program stored in a nonvolatile memory, such as a NOR flash or mask ROM, to a RAM and executes the program in the RAM. Since the RAM is superior to the nonvolatile memory in high-speed access, it can increase the execution speed of programs. However, since the time to load the program stored in the nonvolatile memory or expand a program to the nonvolatile memory is required, the start-up time of the device tends to increase.

To shorten the start-up time of the device, for example, a system that causes a CPU to directly execute the program stored in a memory, such as a NOR flash or mask ROM, has been proposed. When the program is frequently executed, however, the CPU has to frequently access the nonvolatile memory inferior to the RAM in high-speed access, decreasing the overall processing speed.

To overcome this problem, Jpn. Pat. Appln. KOKAI Publication No. 2008-15725 (patent document 1) has disclosed the technique for, when the power supply is turned on, virtual addresses constituting a program execution region are mapped to the physical memory region of a flash memory, the program is caused to run on the flash memory. Thereafter, the program is loaded into a RAM, and the virtual addresses are remapped to a physical memory region of the RAM.

In the technique disclosed in the first patent document, all of the programs are loaded into the RAM. Therefore, even if a program is referred to only immediately after, for example, the power supply is turned on (or in the middle of start-up), the program is loaded into the RAM after the start-up, which not only produces a wasteful load time but also applies an unnecessary load to the system.

### BRIEF DESCRIPTION OF THE SEVERAL VIEWS OF THE DRAWINGS

A general architecture that implements the various features of the invention will now be described with reference to the drawings. The drawings and the associated description are provided to illustrate embodiments of the invention and not to limit the scope of the invention.

FIG. 1 schematically shows the configuration of a program execution apparatus according to an embodiment of the invention;

FIG. 2A shows a state where a virtual memory and a program memory are mapped during the start-up of the program execution apparatus in the embodiment;

FIG. 2B shows a state where the mapping of the virtual memory and program memory is made invalid immediately after the program execution apparatus is started up in the embodiment;

FIG. 2C shows a state where the virtual memory and program memory are mapped immediately after the program execution apparatus is starting up in the embodiment;

FIG. 3 is a flowchart to explain a first program execution process in the embodiment;

FIG. 4 shows a state where the virtual memory and program memory are mapped and the virtual memory and main memory are mapped in the embodiment; and

FIG. 5 is a flowchart to explain a second program execution process in the embodiment.

### DETAILED DESCRIPTION

Various embodiments according to the invention will be described hereinafter with reference to the accompanying drawings. In general, a program execution apparatus according to one embodiment of the invention comprises: a first memory configured to store a first program; a second memory configured to store a partial program loaded from the first memory or a second program loaded from one other memory; and a controller configured to perform first correspondence to cause a first storage region of the first program in the first memory to correspond to a first virtual region of a virtual memory, execute the first program stored in the first memory on the basis of the first correspondence according to a request for the execution of the first program, write the partial program or the second program to the second memory according to a request for the execution of the partial program or a request for the execution of the second program, perform second correspondence to cause the partial program in the second memory or a second storage region of the second program to correspond to a second virtual region of the virtual memory, and execute the partial program or the second program stored in the second memory on the basis of the second correspondence.

Hereinafter, referring to the accompanying drawings, an embodiment of the invention will be explained.

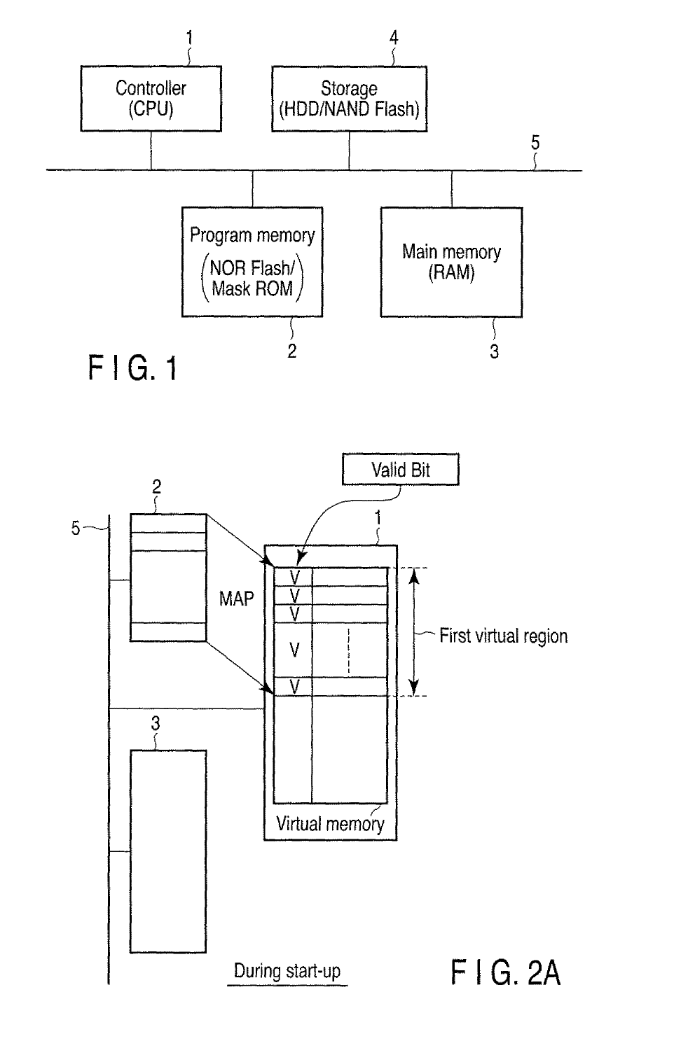

FIG. 1 schematically shows a program execution apparatus according to an embodiment of the invention. The program execution apparatus can be applied to a personal computer, a digital TV, a hard disk recorder, or the like.

As shown in FIG. 1, the program execution apparatus comprises a controller 1 which can be composed of a CPU or the like, a program memory 2, such as a NOR flash or mask ROM, a main memory which can be composed of a RAM or the like, and storage 4 which can be composed of a hard disk drive (HOD), NAND flash memory, or the like. The controller 1, program memory 2, main memory 3, and storage 4 are connected with one another via a bus 5.

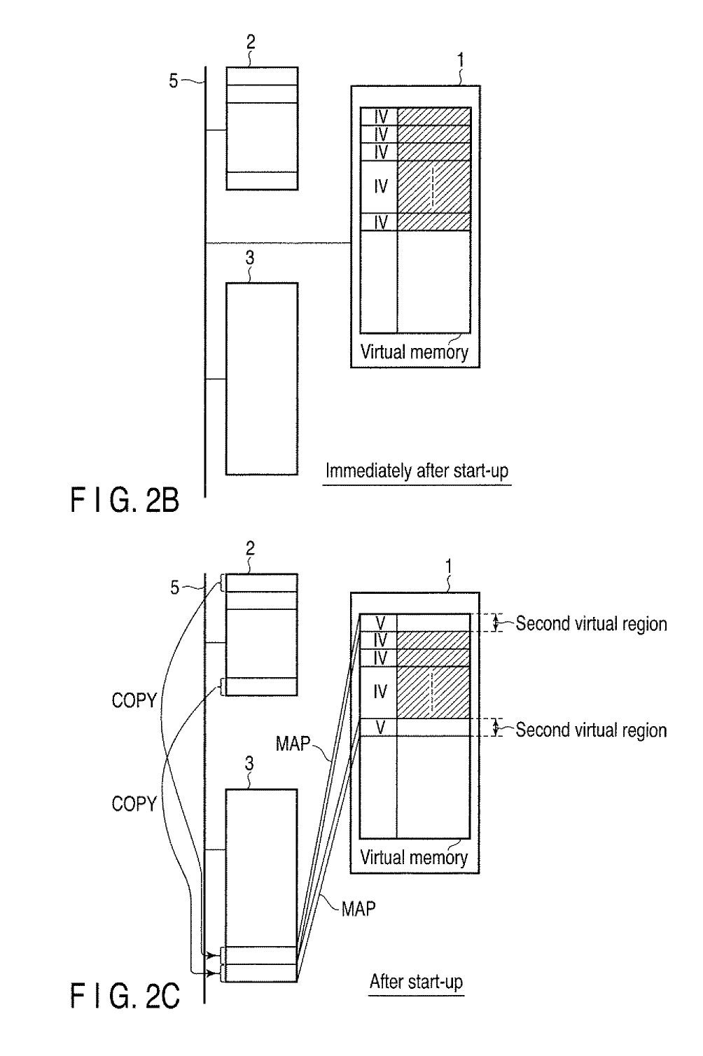

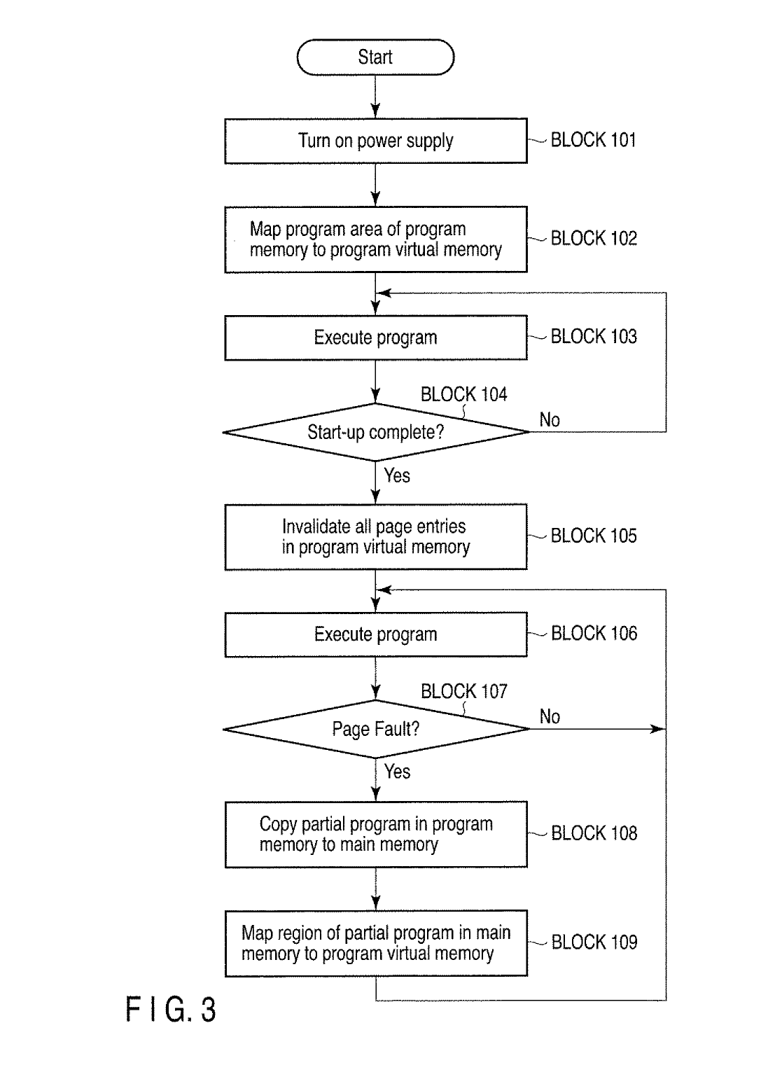

Next, a first program execution process by the program execution apparatus will be explained with reference to FIGS. 2A to 2C and 3. FIG. 2A shows a state where a virtual memory and the program memory 2 are mapped (or are caused to correspond to each other) during the start-up of the program execution apparatus. FIG. 2B shows a state where the mapping of the virtual memory and program memory 2 is made invalid immediately after the start-up of the program execution apparatus. FIG. 2C shows a state where the virtual memory and main memory 3 are mapped immediately after the start-up of the program execution apparatus. FIG. 3 is a flowchart to explain a first program execution process.

The program execution apparatus, during the start-up, directly executes the program stored in the program memory 2. After the start-up, the program execution apparatus loads only the necessary one of (or partial program) of the programs stored in the program memory 2 into the main memory 3, and executes the partial program loaded in the main memory 3. A detailed explanation will be given below.

When the power supply of the program execution apparatus is turned on (BLOCK 101), an operating system causes a controller 1 to create a virtual memory space to run the program stored in the program memory 2.

As shown in FIG. 2A, the controller 1 also maps a first storage region of the program stored in the program memory 2 and a first virtual region of the virtual memory space to directly execute the program stored in the program memory 2 (BLOCK 102). Specifically, the controller 1 sets first correspondence information that causes a plurality of pages constituting a first storage region of the program in the program memory 2 to correspond to a plurality of pages constituting a first virtual region of the virtual memory space and makes valid (V) each page entry included in the first correspondence information. By making each page entry valid, the controller 1, when accessing the virtual memory space (first virtual region), can access the program in the program memory 2 on the basis of the first correspondence information without the occurrence of an exception called a page fault and execute the program (BLOCK 103).

After the start-up process is completed as a result of the execution of the program (YES in BLOCK 104), the controller 1 makes invalid (IV) each page entry included in the first correspondence information as shown in FIG. 2B (BLOCK 105). In a case where the program execution apparatus is applied to digital TV, the completion of the start-up process corresponds to, for example, the completion of broadcast display.

As described above, by making invalid each page entry included in the first correspondence information, an exception will occur when the controller 1 accesses the virtual memory space (first virtual region). Specifically, when the controller 1 has accessed the virtual memory space (first virtual region) according to a request for the execution of the partial program of the program stored in the program memory 2 (BLOCK 106), an exception occurs (YES in BLOCK 107).

As described above, when an exception has occurred after the completion of the start-up process (YES in BLOCK 107), the controller 1, as shown in FIG. 2C, loads the partial program (requested partial program) of the program stored in the program memory 2 into the main memory 3 (BLOCK 108) and sets second correspondence information that causes a partial program page constituting a second storage region (a part of the first storage region) of the partial program in the main memory 3 to correspond to a page constituting a second virtual region (a part of the first virtual region) of the virtual memory space and makes valid (V) each page entry included in the second correspondence information (BLOCK 109).

As can be seen from FIGS. 2A to 2C, each page entry of the second virtual region corresponds to each page entry of a part of the first virtual region. Each page entry of a part of the first virtual region shown in FIG. 2A includes the physical address of the region in which the partial program in the program memory 2 has been stored, whereas each page entry of the second virtual region shown in FIG. 2C includes the physical address of the region in which the partial program written to the main memory 3 has been stored.

Accordingly, on the basis of the request for the execution of the partial program (BLOCK 106), the controller 1, when accessing the virtual memory space (second virtual region), can access the partial program in the main memory 3 on the basis of the second correspondence information without the occurrence of an exception and can execute the partial program.

As described above, the program execution apparatus directly executes the program stored in the program memory 2 at the time of start-up, enabling load time to be omitted and the start-up time to be made shorter. After the start-up, the program execution apparatus writes only the necessary program to the main memory 3 and does not write the program used only for the start-up to the main memory 3. This enables useless load time to be omitted and the storage region of the main memory 3 to be used effectively as compared with a case where the entire program is written to the main memory 3. Furthermore, after the start-up, since the program execution apparatus writes only the necessary programs to the main memory 3 successively, the load of writing programs can be distributed. Moreover, since the program execution apparatus executes the partial program written to the main memory 3 after the start-up, the apparatus can execute the program faster than when the program stored in the program memory 2 is executed directly.

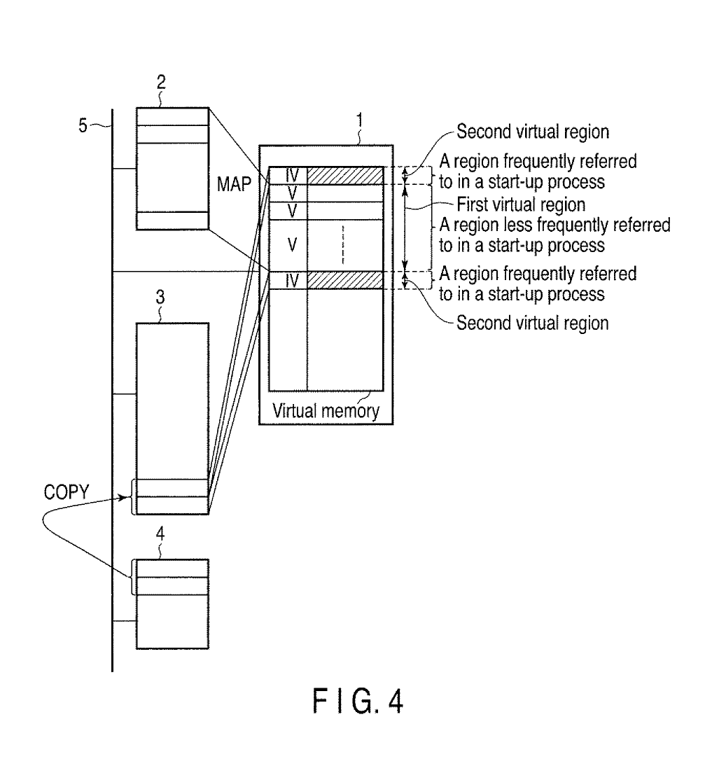

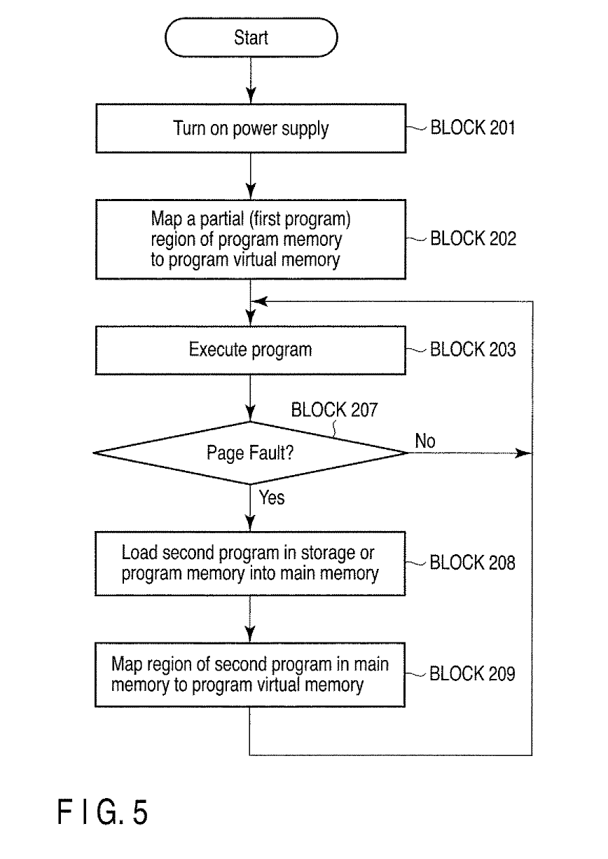

Next, a second program execution process by the program execution apparatus will be explained with reference to FIGS. 4 and 5. FIG. 4 shows a state where the virtual memory and program memory 2 are mapped and the virtual memory and main memory 3 are mapped. FIG. 5 is a flowchart to explain a second program execution process.

The program memory 2 of the program execution apparatus stores a first program with a first frequency of use and the storage 4 stores a second program with a second frequency of use higher than the first frequency of use. On the basis of the result of checking the frequency of program use before shipment of the program execution apparatus, a program (a first program) whose frequency of use is low is stored in the program memory 2 and a program (a second program) whose frequency of use is high is stored in the storage 4 (or program memory 2). For example, in a case where the program execution apparatus is applied to digital TV, how frequently which program is used is counted until an image is displayed on TV (or until the start-up is completed). On the basis of the result of checking the frequency of use, a storage location for each program is determined.

The program execution apparatus maps the first storage region of the first program stored in the program memory 2 and the first virtual region of the virtual memory on the basis of the first correspondence information. When executing the first program, the program execution apparatus directly executes the first program in the program memory 2 on the basis of the first correspondence information. Moreover, when requiring the execution of the second program, the program execution apparatus writes the second program stored to the storage 4 (or program memory 2) to the main memory 3, maps the second storage region of the second program in the main memory 3 and a second virtual region of the virtual memory on the basis of the second correspondence information, and executes the second program in the main memory 3 on the basis of the second correspondence information.

In the first program execution process, for example, all of the programs (first programs) may be stored in the program memory 2 and the program in the program memory 2 be directly executed. After the start-up, only the necessary program (partial program) may be written to the main memory 3 and the program in the main memory 3 be executed.

In contrast, in the second program execution process, for example, of all of the boot programs (first program and second program), the first program whose access frequency is low is stored in the program memory 2 and the second program whose access frequency is high is stored in the storage 4 (or program memory 2). The first program in the program memory 2 is directly executed. When the second program is required, the second program in the storage 4 (or in the program memory 2) is written to the main memory 3 and the second program in the main memory 3 is executed. By doing this, a program execution method can be selected according to the program access frequency, enabling the execution time (start-up time) to be shortened. The details are as described below.

When the power supply of the program execution apparatus is turned on (BLOCK 201), the operating system causes the controller 1 to create a virtual memory space to start up the first program stored in the program memory 2.

Furthermore, as shown in FIG. 4, the controller 1 maps the first storage region of the first program stored in the program memory 2 and the first virtual region of the virtual memory space to directly execute the first program stored in the program memory 2 (BLOCK 202). Specifically, the controller 1 sets first correspondence information that causes a plurality of pages constituting the first storage region of the first program in the program memory 2 to correspond to a plurality of pages constituting the first virtual region of the virtual memory space and makes valid (V) each page entry included in the first correspondence information. By making each page entry valid, the controller 1, when accessing the virtual memory space (first virtual region), can access the first program in the program memory 2 on the basis of the first correspondence information without the occurrence of an exception called a page fault and execute the first program (BLOCK 203).

After the first program is executed, or when the second program is executed without the execution of the first program, that is, when the controller 1 accesses the virtual memory space on the basis of the request for the execution of the second program, an exception occurs (YES in BLOCK 207). When an exception has occurred in this way (YES in BLOCK 207), the controller 1 loads the second program (requested second program) stored in the storage 4 (or program memory 2) into the main memory 3 (BLOCK 208), sets second correspondence information that causes each page constituting the second storage region of the second program in the main memory 3 to correspond to each page constituting the second virtual region of the virtual memory space, and makes valid (V) each page entry included in the second correspondence information (BLOCK 209). Although each page entry included in the second correspondence information seems to be made invalid, FIG. 4 shows a state before the second correspondence information has been set. After the second correspondence information has been set, each page entry included in the second correspondence information is made valid.

Accordingly, on the basis of the request for the execution of the second program (BLOCK 203), the controller 1, when accessing the virtual memory space (second virtual region), can access the second program in the program memory 2 on the basis of the second correspondence information without the occurrence of an exception and execute the second program.

Furthermore, the storage 4 (or program memory 2) may store the compressed second program and the controller 1 may decompress the compressed second program and write the decompressed second program to the main memory 3.

As described above, the program execution apparatus directly executes the first program with a low access frequency stored in the program memory 2 and, when the execution of the second program with a high access frequency stored in the storage 4 or program memory 2 is required, writes the second program to the main memory 3, and executes the second program in the main memory 3. This makes it possible to select a program execution method according to the program access frequency, which enables the execution time (start-up time) to be shortened. Since the second program with a high access frequency can be stored in the storage 4 which is relatively inexpensive, the memory capacity of the program memory 2 which is relatively expensive can be used effectively. Alternatively, a program memory 2 whose memory capacity is low can be used.

The first and second program execution processes described above can be applied to, for example, a boot process. Moreover, the first and second program execution processes can be realized by a program (hereinafter, referred to as a streamlining program). The streamlining program is installed in the program execution apparatus in advance. Alternatively, the streamlining program may be installed in the program execution apparatus using a storage medium in which the streamlining program has been stored. Furthermore, the streamlining program may be downloaded from a server via a network into the program execution apparatus. Moreover, the first and second program execution processes are realized by the cooperation of the streamlining program, controller 1, operating system, and the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A program execution apparatus comprising:
a first memory configured to store a first program;
a second memory configured to store a partial program loaded from the first memory or a second program loaded from one other memory; and
a controller configured to perform first correspondence to cause a first storage region of the first program in the first memory to correspond to a first virtual region of a virtual memory, execute the first program stored in the first memory on the basis of the first correspondence according to a request for the execution of the first program, write the partial program or the second program to the second memory according to a request for the execution of the partial program or a request for the execution of the second program, perform second correspondence to cause the partial program in the second memory or a second storage region of the second program to correspond to a second virtual region of the virtual memory, and execute the partial program or the second program stored in the second memory on the basis of the second correspondence.

2. The apparatus of claim 1, wherein the controller is configured to execute the first program on the basis of the first correspondence and then make the first correspondence invalid.

3. The apparatus of claim 1, wherein the controller is configured to
make valid first correspondence information that causes a plurality of pages constituting the first storage region of the first program in the first memory to correspond to a plurality of pages constituting the first virtual region of the virtual memory,
execute the first program stored in the first memory on the basis of the first correspondence information made valid,
make invalid the first correspondence information made valid,
write the partial program to the second memory according to a request for the execution of the partial program,
make valid second correspondence information that causes a partial program page constituting the second storage region of the partial program in the second memory to correspond to the second virtual region of the virtual memory, and
execute the partial program stored in the second memory on the basis of the second correspondence information made valid.

4. The apparatus of claim 3, wherein the first program is a boot program, and
the controller is configured to start up a system by the execution of the first program and, after the completion of the start-up, make invalid the first correspondence information made valid.

5. The apparatus of claim 1, wherein the controller maintains the first correspondence, regardless of the occurrence or non-occurrence of the execution of the first program on the basis of the first correspondence, writes the second program to the second memory according to a request of the execution of the second program, and performs the second correspondence.

6. The apparatus of claim 1, wherein the controller is configured to
make valid first correspondence information that causes a plurality of pages constituting the first storage region of the first program in the first memory to correspond to a plurality of pages constituting the first virtual region of the virtual memory,
execute the first program stored in the first memory on the basis of the first correspondence information made valid if the execution of the first program is requested, and maintain the first correspondence information made valid even if the execution of the first program is not requested,
write the second program to the second memory according to a request for the execution of the second program,
make valid second correspondence information that causes a second program page constituting the second storage region of the second program in the second memory to correspond to a page constituting the second virtual region of the virtual memory, and
execute the second program stored in the second memory on the basis of the second correspondence information made valid.

7. The apparatus of claim 5, wherein the first memory is configured to store the first program with a first frequency of use, and
the second memory is configured to store the second program with a second frequency of use higher than the first frequency of use.

8. The apparatus of claim 5, wherein the controller is configured to decompress the compressed second program stored in the one other memory and write the decompressed second program to the second memory.

9. A program configured to cause a computer to:
perform first correspondence to cause a first storage region of a first program in a first memory to correspond to a first virtual region of a virtual memory;
execute the first program stored in the first memory on the basis of the first correspondence according to a request for the execution of the first program;
write the partial program or the second program to the second memory according to a request for the execution of a partial program of the first program or a request for the execution of a second program;
perform second first correspondence that causes the partial program or a second storage region of the second program in the second memory to correspond to a second virtual region of the virtual memory; and
execute the partial program or the second program stored in the second memory on the basis of the second correspondence.

10. The program of claim 9, further configured to cause a computer to make invalid the first correspondence after the first program has been executed on the basis of the first correspondence.

11. The program of claim 9, further configured to cause a computer to maintain the first correspondence, regardless of the occurrence or non-occurrence of the execution of the first program on the basis of the first correspondence, write the second program to the second memory according to a request for the execution of the second program, and perform the second correspondence.

12. A program execution method comprising:
performing first correspondence to cause a first storage region of a first program in a first memory to correspond to a first virtual region of a virtual memory;
executing the first program stored in the first memory on the basis of the first correspondence according to a request for the execution of the first program;
according to a request for the execution of a partial program of the first program or a request for the execution of a second program, writing the partial program or the second program to the second memory;
performing second first correspondence to cause the partial program or a second storage region of the second program in the second memory to correspond to a second virtual region of the virtual memory; and
executing the partial program stored or the second program in the second memory on the basis of the second correspondence.
